(19) United States
(12) Patent Application Publication
(10) Pub. No.: US 2025/0118201 A1
(43) Pub. Date: Apr. 10, 2025

(54) VEHICLE IDENTIFICATION METHOD

(71) Applicant: TOYOTA JIDOSHA KABUSHIKI KAISHA, Toyota-shi Aichi-ken (JP)

(72) Inventors: Ryuji OKAMURA, Gotemba-shi Shizuoka-ken (JP); Tatsuya SUGANO, Sunto-gun Shizuoka-ken (JP); Koji MORITA, Gotemba-shi Shizuoka-ken (JP); Daisuke KAKUMA, Susono-shi Shizuoka-ken (JP); Nobutsugu MARUIWA, Mishima-shi Shizuoka-ken (JP); Hiroya CHIBA, Fuji-shi Shizuoka-ken (JP)

(73) Assignee: TOYOTA JIDOSHA KABUSHIKI KAISHA, Toyota-shi Aichi-ken (JP)

(21) Appl. No.: 18/892,676

(22) Filed: Sep. 23, 2024

(30) Foreign Application Priority Data
Oct. 10, 2023 (JP) 2023-175139

(51) Int. Cl. G08G 1/0967; H04W 4/44; H04W 12/0433

(52) U.S. Cl. CPC G08G 1/096725; H04W 4/44; H04W 12/0433

(57) ABSTRACT

A vehicle identification method for identifying a target vehicle includes the following first to sixth steps. The first step is, in a management system, generating information indicating a second action from information indicating a first action using a first key. The second step is transmitting the information indicating the second action from the management system to the target vehicle. The third step is, in the target vehicle, restoring the information indicating the first action from the information indicating the second action using a second key. The fourth step is causing the target vehicle to perform the first action. The fifth step is, in the management system, detecting an action performed by a vehicle. The sixth step is, in the management system, identifying the vehicle performing the first action as the target vehicle and not identifying the vehicle performing the second action as the target vehicle.

### CROSS-REFERENCE TO RELATED APPLICATION

The present disclosure claims priority to Japanese Patent Application No. 2023-175139, filed on Oct. 10, 2023, the contents of which application are incorporated herein by reference in their entirety.

### TECHNICAL FIELD

The present disclosure relates to a technique for identifying a target vehicle.

### BACKGROUND ART

Identifying a target vehicle is important in a function of managing and controlling vehicles. For example, in the case of automated valet parking (AVP) in a parking lot, it is required to identify a target vehicle of the AVP from the viewpoint of reliability and safety of functions.

Patent Literature 1 discloses a vehicle authentication method in a parking lot as a technique for identifying a target vehicle. The vehicle authentication method disclosed in Patent Literature 1 transmits information instructing a target vehicle to perform a predetermined action, confirms whether a vehicle in a parking lot has performed the predetermined action, and performs localization by authenticating the vehicle that has performed the predetermined action as the target vehicle.

In addition, the following Patent Literatures 2 to 4 are documents showing the technical level of the present technical field.

### List of Related Art

Patent Literature 1: U.S. Pat. No. 10,532,771 B2
Patent Literature 2: JP 2003101530 A
Patent Literature 3: JP 2015005970 A
Patent Literature 4: JP 2018142823 A

### SUMMARY

According to the technique disclosed in Patent Literature 1, a vehicle that has performed a predetermined action in accordance with transmitted information is identified as a target vehicle. However, there is a possibility that a malicious third party intercepts the information transmitted to the target vehicle and causes an unrelated vehicle that is not the target vehicle to perform the predetermined action. In this case, there is a risk that the unrelated vehicle may be identified as the target vehicle. This is not desirable from the viewpoint of reliability and safety of the function. As described above, the conventional technique that performs vehicle identification based on an action of a vehicle has a problem in terms of reliability and safety.

An object of the present disclosure is, in view of the above problems, to provide a technique capable of more appropriately ensuring reliability and safety with respect to the technique for performing vehicle identification based on an action of a vehicle.

The first to fourth disclosures each relate to a vehicle identification method for identifying a target vehicle.

A vehicle identification method according to the first disclosure includes:
in a management system, generating information indicating a second action from information indicating a first action using a first key;
transmitting the information indicating the second action from the management system to the target vehicle;
in the target vehicle, restoring the information indicating the first action from the information indicating the second action using a second key associated with the first key;
causing the target vehicle to perform the first action;
in the management system, detecting an action performed by a vehicle using a sensor; and
in the management system, identifying the vehicle performing the first action as the target vehicle and not identifying the vehicle performing the second action as the target vehicle.

A vehicle identification method according to the second disclosure includes:
transmitting information indicating both a first action and a second action from a management system to the target vehicle;
causing the target vehicle to perform only the first action without performing the second action;
in the management system, detecting an action performed by a vehicle using a sensor; and
in the management system, identifying the vehicle that performs the first action without performing the second action as the target vehicle, and not identifying the vehicle that performs both the first action and second action as the target vehicle.

A vehicle identification method according to the third disclosure includes:
transmitting information of a plurality of elements constituting a target action separately from a management system to the target vehicle via each of a plurality of different communication paths;
causing the target vehicle to perform the target action including all of the plurality of elements;
in the management system, detecting an action performed by a vehicle using a sensor; and
in the management system, identifying the vehicle that performs the target action including all of the plurality of elements as the target vehicle, and not identifying the vehicle that performs the action not including at least one of the plurality of elements as the target vehicle.

A vehicle identification method according to the fourth disclosure includes:
transmitting information of a target action including a plurality of actions that are consecutive in time from a management system to the target vehicle;
causing the target vehicle to perform the target action;
in the management system, detecting an action performed by a vehicle using a sensor; and
in the management system, comparing the detected action with the plurality of actions, and identifying the vehicle as the target vehicle when a predetermined number or more of actions among the plurality of actions are detected.

The fifth to eighth disclosures each relate to a vehicle identification system for identifying a target vehicle. The vehicle identification system according to the fifth to eighth disclosures comprises a management system capable of communicating with the target vehicle.

In the vehicle identification system according to the fifth disclosure,
the management system generates information indicating a second action from information indicating a first action using a first key,
the management system transmits the information indicating the second action to the target vehicle,
the target vehicle restores the information indicating the first action from the information indicating the second action using a second key associated with the first key,
the management system detects an action performed by a vehicle using a sensor, and
the management system identifies the vehicle performing the first action as the target vehicle and not identifying the vehicle performing the second action as the target vehicle.

In the vehicle identification system according to the sixth disclosure,
the management system transmits information indicating both a first action and a second action to the target vehicle,
the target vehicle performs only the first action without performing the second action,
the management system detects an action performed by a vehicle using a sensor, and
the management system identifies the vehicle that performs the first action without performing the second action as the target vehicle, and does not identify the vehicle that performs both the first action and second action as the target vehicle.

In the vehicle identification system according to the seventh disclosure includes:
the management system transmits information of a plurality of elements constituting a target action separately to the target vehicle via each of a plurality of different communication paths,
the target vehicle performs the target action including all of the plurality of elements,
the management system detects an action performed by a vehicle using a sensor, and
the management system identifies the vehicle that performs the target action including all of the plurality of elements as the target vehicle, and does not identify the vehicle that performs the action not including at least one of the plurality of elements as the target vehicle.

In the vehicle identification system according to the eighth disclosure,
the management system transmits information of a target action including a plurality of actions that are consecutive in time to the target vehicle,
the target vehicle performs the target action,
the management system detects an action performed by a vehicle using a sensor, and
the management system compares the detected action with the plurality of actions, and identifies the vehicle as the target vehicle when a predetermined number or more of actions among the plurality of actions are detected.

According to the present disclosure, it is possible to more appropriately ensure reliability and safety with respect to a technique for performing vehicle identification based on an action of a vehicle.

### BRIEF DESCRIPTION OF DRAWINGS

FIG. 1 is a conceptual diagram for explaining automated valet parking (AVP) in a parking lot;

FIG. 2 is a diagram showing an example of a configuration of a management system;

FIG. 3 is a conceptual diagram for explaining an outline of a conventionally proposed action-based identification method;

FIG. 4 is a conceptual diagram for explaining an outline of a vehicle identification method according to a first embodiment;

FIG. 5 is a diagram showing an example of a first action and a second action in the vehicle identification method according to the first embodiment;

FIG. 6 is a diagram showing an example of a configuration of a vehicle identification system according to an embodiment;

FIG. 7 is a diagram showing an example of a processing flow of the vehicle identification method according to the first embodiment;

FIG. 8 is a diagram showing an example of a configuration of the vehicle identification system according to a modification of the first embodiment;

FIG. 9 is a diagram showing an example of a processing flow of the vehicle identification method according to a modification of the first embodiment;

FIG. 10 is a conceptual diagram for explaining an outline of a vehicle identification method according to a second embodiment;

FIG. 11 is a diagram showing an example of a processing flow of the vehicle identification method according to the second embodiment;

FIG. 12 is a conceptual diagram for explaining an outline of a vehicle identification method according to a third embodiment;

FIG. 13 is a diagram showing an example of a processing flow of the vehicle identification method according to the third embodiment;

FIG. 14 is a conceptual diagram for explaining an outline of a vehicle identification method according to a fourth embodiment;

FIG. 15 is a conceptual diagram showing a practical example of the vehicle identification method according to the fourth embodiment; and

FIG. 16 is a diagram showing an example of a processing flow of the vehicle identification method according to the fourth embodiment.

### DETAILED DESCRIPTION

A function of providing control and service to a target vehicle in a predetermined area where a vehicle enters and exits is considered. One of such functions is automated valet parking (AVP) in a parking lot. The AVP performs the entry and exit of the target vehicle in the parking lot by autonomous driving. In addition, a function of carrying in and out the target vehicle in a garage by a transporting device is exemplified.

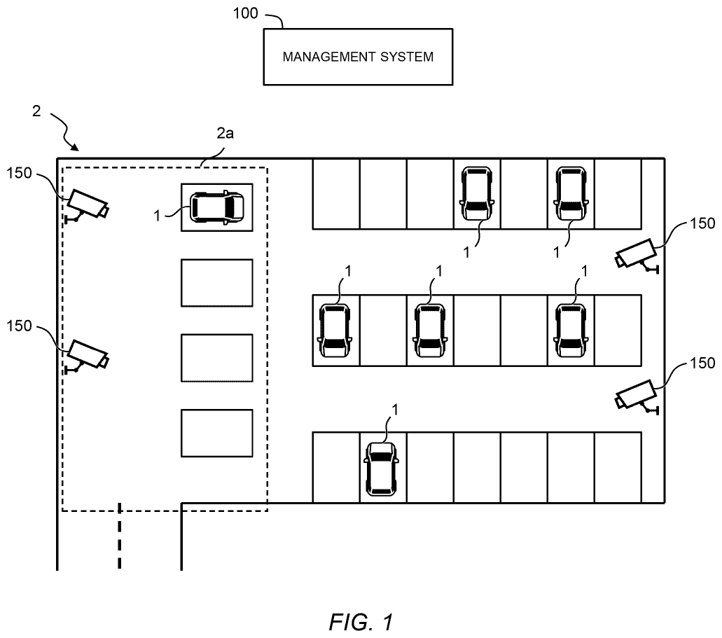

FIG. 1 is a conceptual diagram for explaining AVP. A management system 100 manages AVP in an area 2 (parking lot). The management system 100 includes a sensor 150 installed in the area 2. The sensor 150 detects the position and state of each vehicle 1 in the area 2. The management system 100 manages information of each vehicle 1 based on detection information acquired using the sensor 150. Then, the management system 100 communicates with the target vehicle in the area 2 and performs AVP of the target vehicle. More specifically, the management system 100 transmits command information related to AVP to the target vehicle based on management data regarding each vehicle 1 and the area 2. A control system of the target vehicle controls the target vehicle according to the received command information, thereby AVP is performed. Similarly, other functions of providing control and service to the target vehicle (hereinafter referred to as a function of AVP or the like) are also performed by cooperation between the management system 100 and the control system of the vehicle 1.

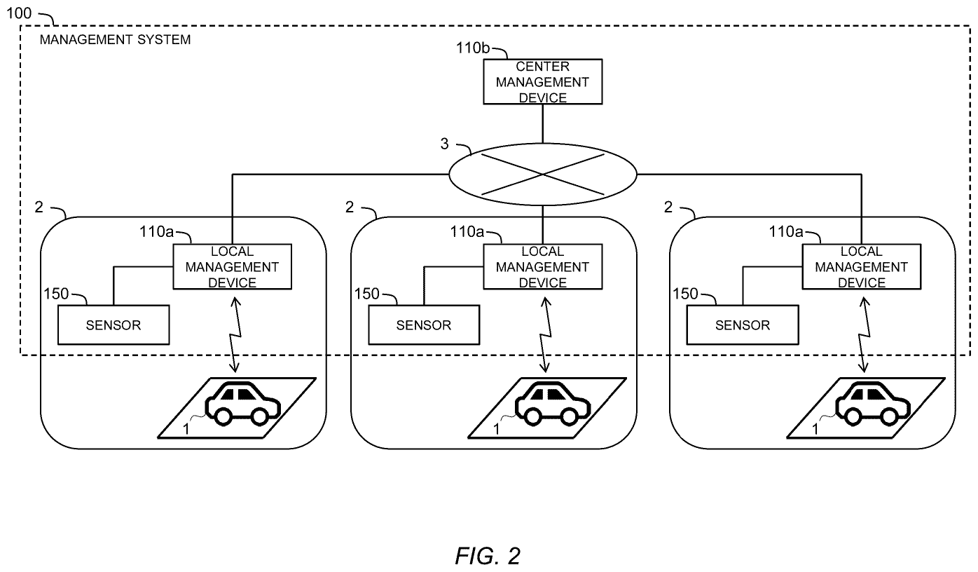

It is considered that the function of AVP or the like is generally provided over a plurality of areas 2. Accordingly, the management system 100 may be configured as follows. FIG. 2 is a diagram showing an example of a configuration of the management system 100. The management system 100 is configured to include a plurality of local management devices 110a provided in a plurality of areas 2 and a center management device 110b that manages the plurality of local management devices 110a. Each local management device 110a manages the function in the corresponding area 2. Each local management device 110a is communicatively connected to the sensor 150 of the corresponding area 2. And each local management device 110a is configured to be able to communicate with the vehicle 1 in the corresponding area 2 via a wireless local area network (LAN) or the like. The center management device 110b manages information over the plurality of areas 2. For example, the center management device 110b manages user information, optimizes the entire plurality of areas 2, and the like. The center management device 110b is communicatively connected to the plurality of local management devices 110a via a communication network 3 (e.g., the Internet). The center management device 110b may be configured to be able to communicate with the vehicle 1 via the communication network 3.

In the function of AVP or the like described above, it is required to identify the target vehicle from the viewpoint of reliability and safety (identification can also be called authentication). For example, consider a case where a user intends to park the vehicle 1 by the AVP with reference to FIG. 1. The user stops the vehicle 1 (target vehicle) to be entered at an entry position 2a and makes a request for AVP. Here, in order to confirm whether the vehicle 1 in the entry position 2a is really the vehicle 1 (target vehicle) of the legitimate user, vehicle identification of the target vehicle is performed. When the vehicle identification is successful, the vehicle 1 in the entry position 2a is determined to be a legitimate vehicle (target vehicle). After the vehicle 1 is determined to be a legitimate vehicle, AVP starts, and the entry of the target vehicle is performed. Therefore, by normally identifying the target vehicle, it is possible to allow only the legitimate vehicle to enter. Conversely, if the target vehicle is not identified, there is a risk that an unrelated vehicle which is not the target vehicle may enter. This is a problem from the viewpoint of reliability and safety. As described above, in the function of AVP or the like, the identification of the target vehicle is important in order to ensure reliability and safety.

A vehicle identification method according to the embodiment can be used to identify a target vehicle in the function of AVP or the like. In particular, the vehicle identification method according to the embodiment is one of methods for causing a target vehicle to perform an action and performing identification based on whether or not the action matches an expected action (hereinafter referred to as an “action-based identification method”).

Here, the action is defined by a combination of a device for performing the action and an operation pattern of the device. Examples of the device for performing the action include a lighting device (headlights, brake lights, fog lights, or the like), an interior lighting device, a horn, a direction indicator, wipers, a door, a door window, an engine, an electric motor, and the like.

For example, one of the actions of the vehicle 1 is to turn the headlights on and off in a specified pattern. And for example, one of the actions of the vehicle 1 is to blink the left and right turn lights of the direction indicator in a specified pattern. And for example, one of the actions of the vehicle 1 is to operate the wipers in a specified pattern. And for example, one of the actions of the vehicle 1 is to open and close the door or the door window in a specified pattern. And for example, one of the actions of the vehicle 1 is to sound the horn in a specified pattern. And for example, one of the actions of the vehicle 1 is to start the engine (rev up the engine) in a specified pattern.

The operation pattern is represented by, for example, a signal indicating the operation state of the device in time series. Alternatively, the operation pattern may be represented by a signal indicating a sequence of the operation state of the device. The action may include a request for a repetition of an operation pattern. One action may include an operation pattern of a plurality of devices.

In the action-based identification method, the management system 100 needs to detect an action of the vehicle 1 using the sensor 150. Therefore, the sensor 150 is configured to be able to detect at least an action that is assumed to be performed by a vehicle. For example, when a visible action which is an action that can be visually detected (an action related to lighting of a lighting device, an action related to operation of wipers, or the like) is assumed, the sensor 150 is configured to include a sensor capable of detecting visual information, such as a camera, LiDAR (Light Detection And Ranging), an illuminance sensor, or the like. For example, when an audible action which is an action that can be audibly detected (an action related to sounding of a horn, an action related to driving of an engine or an electric motor, or the like) is assumed, the sensor 150 is configured to include a sensor capable of detecting auditory information, such as a microphone.

The action-based identification method has advantages such as a degree of freedom in an action used for identification and a high degree of variability as an identification method. However, the action-based identification method essentially requires transmitting information about an action to a target vehicle. Therefore, the transmitted information may be read by interception. For this reason, in the conventionally proposed action-based identification method (e.g., the method disclosed in Patent Literature 1), it is anticipated that an unrelated vehicle that is not a target vehicle is identified as the target vehicle. Hereinafter, the conventionally proposed action-based identification method will be briefly described as a comparative example.

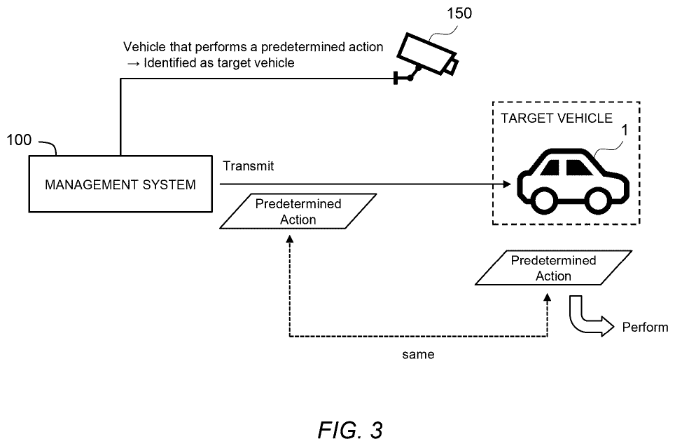

FIG. 3 is a diagram showing an outline of the conventional method. In the conventional method, first, the management system 100 transmits information indicating a predetermined action to a target vehicle. Next, the target vehicle is caused to perform the predetermined action. Next, in the management system 100, an action performed by the vehicle 1 is detected using the sensor 150. Then, in the management system 100, the vehicle 1 that performs the predetermined action is identified as the target vehicle.

When the conventional method is applied, a third party can read the predetermined action by interception. Therefore, the third party may cause an unrelated vehicle to perform the read predetermined action. Moreover, in the conventional method, the action indicated by transmitted information and the action performed to be identified as the target vehicle are the same predetermined action. Therefore, in this case, even though the identification of the target vehicle is performed, an unrelated vehicle is identified as the target vehicle. As a result, for example in AVP, a situation in which the unrelated vehicle is entered may occur. As described above, the conventional method still has problems in terms of reliability and safety.

Furthermore, in the action-based identification method, the sensor 150 is used to detect an action performed by the vehicle 1. Then, identification is performed based on whether or not a detected action matches an expected action. However, in the action-based identification method, there is a possibility that a temporary processing failure or a recognition error occurs in the sensor 150. When a temporary processing failure or a recognition error occurs, a part of the detected action may not accurately reflect the action that was actually performed. For this reason, a situation in which the vehicle 1 that actually performs the expected action is not identified as the target vehicle may occur. This also poses a problem in terms of reliability.

The present disclosure proposes a technique for solving the above problems. In the following, several embodiments of the vehicle identification method will be described in detail.

### 1. First Embodiment

### 1.1 Outline

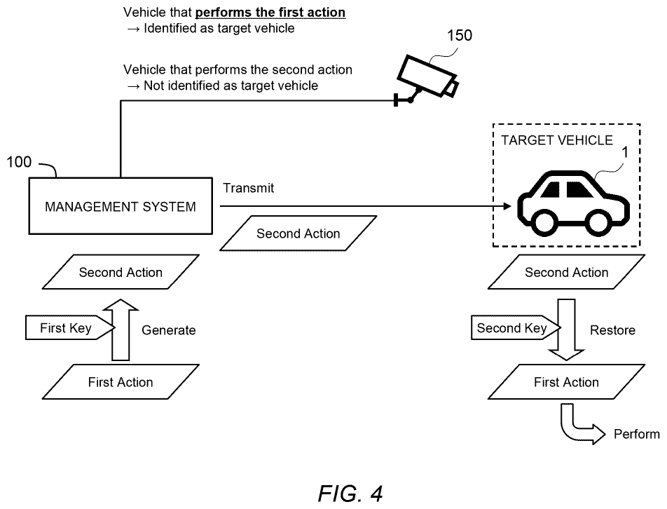

FIG. 4 is a conceptual diagram for explaining an outline of the vehicle identification method according to a first embodiment (hereinafter, simply referred to as the “first vehicle identification method”).

In the first vehicle identification method, the management system 100 manages a first action. The first action may be selected from among a plurality of candidate actions to be managed. Alternatively, the first action may be selected according to a target vehicle from a plurality of actions managed for each vehicle 1. Alternatively, the first action may be selected according to a user related to the target vehicle from a plurality of actions managed for each user.

First, in the first vehicle identification method, the management system 100 generates information indicating a second action from information indicating the first action using a first key.

The first key is typically an encryption key for performing encryption in accordance with a predetermined encryption method. That is, in this case, the information indicating the second action is generated by encrypting the information indicating the first action. For example, the information indicating the second action is information generated by encryption in which information relating to the operation pattern among the information indicating the first action is transformed. The encryption of the information relating to the operation pattern is performed by, for example, inverting bit information, shifting bit information, changing the pulse width, or a combination thereof.

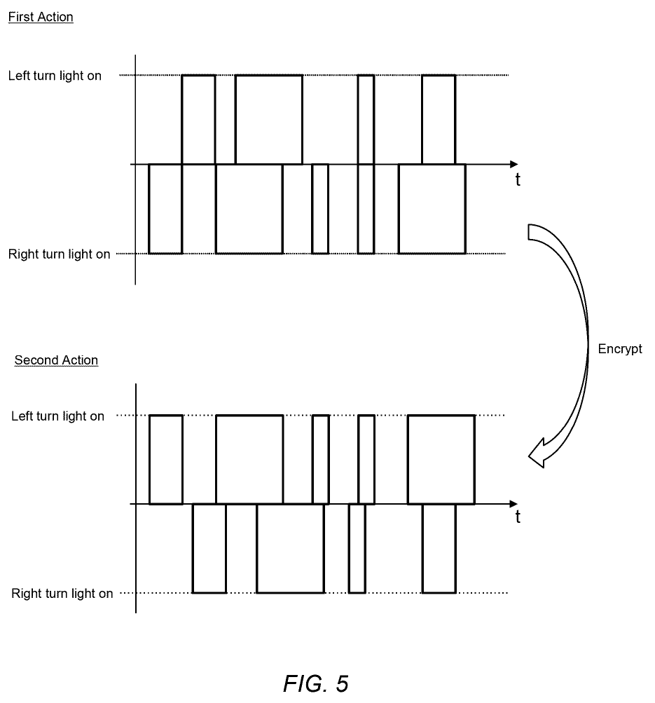

FIG. 5 is a diagram showing an example of the first action and the second action in the first vehicle identification method. In FIG. 5, a blinking pattern (operation pattern) of the left and right turn lights of a direction indicator is shown for each of the first action and the second action. In FIG. 5, the blinking pattern related to the second action is generated by encryption in which the blinking pattern related to the first action is transformed. The information indicating the second action may not be directly generated by encryption. For example, the information related to the operation pattern of the first action may be encoded, and the encoded information may be encrypted with the first key. Then, the information indicating the second action may be generated by decoding the code of the ciphertext.

The information indicating the second action may be generated by encryption in which information relating to the device for performing the action is transformed. For example, the information relating to the device for performing the action may be transformed from indicating a left turn light to a right turn light. Alternatively, the information indicating the second action may be generated by encryption in which both the information relating to the device for performing the action and the information relating to the operation pattern. However, it is desirable that the encryption is performed in such a way that the combination of the device for performing the action and the operation pattern in the second action is not contradictory.

Refer to FIG. 4 again. Next, in the first vehicle identification method, the generated information indicating the second action is transmitted from the management system 100 to the target vehicle. The transmission of the information indicating the second action may be performed by the local management device 110a or may be performed by the center management device 110b. For example, in AVP, the local management device 110a transmits the information indicating the second action to the target vehicle after establishing communication with the target vehicle that has approached the corresponding parking lot. And for example, in the AVP, the center management device 110b transmits the information indicating the second action to the target vehicle in advance when a user reserves AVP.

Next, in the first vehicle identification method, the target vehicle restores the information indicating the first action from the information indicating the second action using a second key associated with the first key.

The second key is typically a decryption key capable of decrypting the ciphertext encrypted by the first key. The first key and the second key may adopt a common key cryptography. That is, in this case, the first key and the second key are common keys. The first key and the second key, which are common keys, may be managed in advance in the management system 100 and the target vehicle, respectively. Furthermore, the pair of the first key and the second key, which are common keys, may be different for each vehicle 1. For example, the management system 100 may be configured to manage the first key for each vehicle 1 and select the first key according to the target vehicle. Alternatively, the common key may be a temporary key used only once in one process. For example, the center management device 110b of the management system 100 may generate a temporary key, which is a common key, and transmit the temporary key to each of the local management device 110a and the target vehicle.

The first key and the second key may adopt a public key cryptography. In this case, the second key is a private key, and the first key is a public key generated from the private key. The second key, which is a private key, is managed in advance in the target vehicle. Then, information of the first key (public key) generated from the second key (private key) is transmitted from the target vehicle to the management system 100. The management system 100 manages the received first key (public key).

It is also possible to adopt a combination of the common key cryptography and the public key cryptography. In this case, the first key includes a first common key that is a common key and a first public key that is a public key. The second key includes a second common key that is a common key corresponding to the first common key and a second public key that is a private key corresponding to the first private key. The management system 100 generates the information indicating the second action from the information indicating the first action in two stages of the first common key and the first public key. The target vehicle restores the information indicating the first action from the information indicating the second action using the first common key and the second private key.

The process of restoring the information indicating the first action may be executed by the control system of the target vehicle. For example, the control system of the target vehicle decrypts the received information relating to the operation pattern of the second action using the second key, thereby restoring the information indicating the first action from the information indicating the second action.

Next, in the first vehicle identification method, the target vehicle is caused to perform the restored first action. For example, the control system of the target vehicle controls the device of the target vehicle according to the content of the restored first action. The control system of the target vehicle may be configured to start control in response to command information instructing performance of the action from the local management device 110a. The local management device 110a may transmit the command information instructing performance of the action together with the information indicating the second action.

Next, in the first vehicle identification method, the management system 100 detects an action performed by the vehicle 1 using the sensor 150. The sensor 150 is configured to be able to detect at least an action assumed as the first action. As described above, the first action is managed by the management system 100. Therefore, the action assumed as the first action can be suitably designed in advance according to the environment to which the first vehicle identification method is applied.

In the first vehicle identification method, the management system 100 identifies the vehicle 1 that performs the first action as the target vehicle. The vehicle 1 that performs an action other than the first action is not identified as the target vehicle. In particular, the vehicle 1 that performs the second action indicated by the transmitted information is not identified as the target vehicle.

As described above, according to the first vehicle identification method, in the management system 100, the information indicating the second action is generated from the information indicating the first action using the first key. Furthermore, the information indicating the second action is transmitted from the management system 100 to the target vehicle. Then, in the management system 100, the vehicle 1 that performs the first action is identified as the target vehicle. In this way, according to the first vehicle identification method, the vehicle 1 that performs the first action for which no information is transmitted, not the second action indicated by transmitted information, is identified as the target vehicle. Thus, even if information transmitted from the management system 100 to the target vehicle is intercepted, an unrelated vehicle is prevented from being identified as the target vehicle. As a result, it is possible to more appropriately ensure reliability and safety in the action-based vehicle identification method.

By the way, in the first vehicle identification method, the vehicle 1 that performs the second action is considered to be the vehicle 1 that performs an action acquired by a malicious third party through interception. This is more remarkable as the content of the second action is more complicated. Therefore, the management system 100 may be configured to exclude the vehicle 1 from the target of identification when the vehicle 1 that performs the second action is detected. In addition, the management system 100 may be configured to issue an alert to a system operator.

### 1.2 Configuration

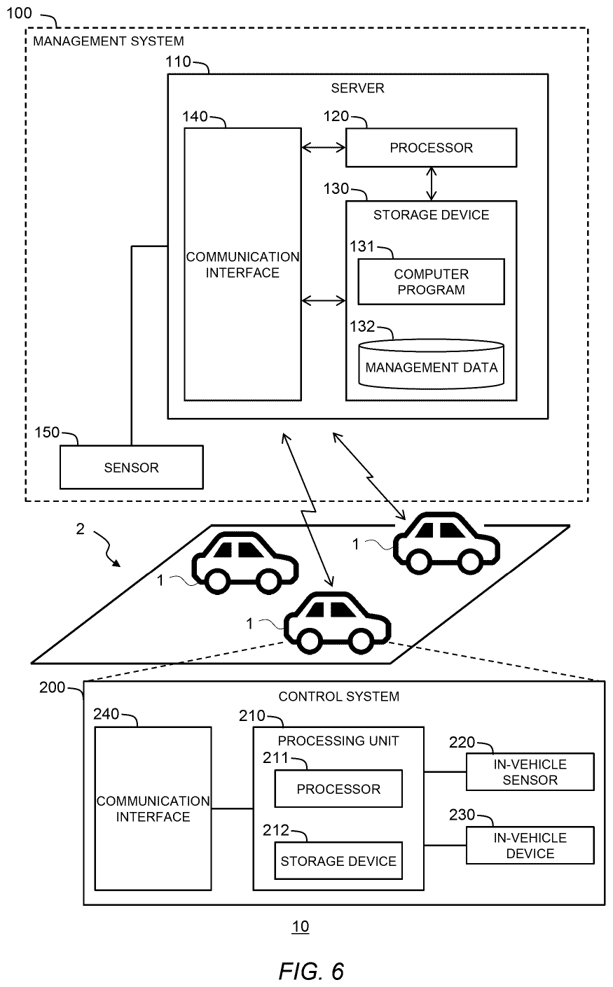

FIG. 6 is a diagram showing an example of the configuration of a vehicle identification system 10 that realizes the first vehicle identification method. The vehicle identification system 10 is configured between the management system 100 and the vehicle 1 that communicates with the management system 100.

The management system 100 includes a server 110 and the sensor 150.

The server 110 is a computer that performs information processing related to various functions in the management system 100. The server 110 is configured to be able to communicate with the vehicle 1 located in the area 2 via a wireless LAN or the like. The server 110 may be considered as the local management device 110a provided in the area 2.

The server 110 is communicably connected to the sensor 150. For example, the server 110 is connected to the sensor 150 by a cable for performing electrical communication or optical communication. As described above, the sensor 150 is configured to be able to detect at least an action assumed as the first action.

The server 110 includes one or more processors 120 (hereinafter, simply referred to as a processor 120 or processing circuitry), a storage device 130, and a communication interface 140.

The processor 120 executes various processes. The processor 120 is configured by, for example, a CPU (Central Processing Unit), a GPU (Graphics Processing Unit), an ASIC (Application Specific Integrated Circuit), an FPGA (Field-Programmable Gate Array), and the like.

The storage device 130 is connected to the processor 120 and stores various kinds of information necessary for processes executed by the processor 120. The storage device 130 is configured by, for example, a recording medium such as a ROM (Read Only Memory), a RAM (Random Access Memory), a HDD (Hard Disk Drive), a SSD (Solid State Drive), and the like.

The storage device 130 stores a computer program 131 and management data 132.

The computer program 131 describes processes to be executed by the processor 120. The information processing by the server 110 may be realized by a cooperation of the processor 120 that executes the processes related to the computer program 131 and the storage device 130. The computer program 131 may be recorded in a computer-readable recording medium.

The management data 132 records various management information. For example, the management data 132 records various vehicle information (vehicle ID, vehicle specifications, and the status of an in-vehicle device 230) and function information (request content, entry time, parking position, scheduled exit time, and the like) for each vehicle 1. In particular, in the first embodiment, the management data 132 manages the first key and the information indicating the first action.

The communication interface 140 is an interface for communicating with an external device of the management system 100 to transmit and receive information. For example, the communication interface 140 is configured by a device for connecting to a mobile communication network, a device for connecting to the Internet, or the like. The server 110 transmits and receives information to and from the vehicle 1 via the communication interface 140.

The vehicle 1 includes a control system 200. The control system 200 controls the vehicle 1 based on various kinds of information.

The control system 200 includes a processing unit 210, an in-vehicle sensor 220, an in-vehicle device 230, and a communication interface 240.

The processing unit 210 is communicably connected to the in-vehicle sensor 220, the in-vehicle device 230, and the communication interface 240. The processing unit 210 is a computer that performs information processing related to control of the vehicle 1 based on various kinds of information. For example, the processing unit 210 is configured by one or more electronic control units (ECUs). Alternatively, the processing unit 210 may be a kit (for example, an AVP kit) for functions provided by the management system 100. The processing unit 210 generates and outputs a control signal for controlling the vehicle 1 by information processing. The control signal output from the processing unit 210 is transmitted to the in-vehicle device 230.

The processing unit 210 includes one or more processors 211 (hereinafter, simply referred to as a processor 211 or processing circuitry) and a storage device 212. The processor 211 executes various processes. The storage device 212 is connected to the processor 211 and stores various kinds of information necessary for processes executed by the processor 211. The storage device 212 may store a computer program that describes processes to be executed by the processor 211. The information processing by the processing unit 210 may be realized by a cooperation of the processor 211 that executes the processes related to the computer program and the storage device 212.

The in-vehicle sensor 220 detects information on the surrounding environment and the traveling state of the vehicle 1. Examples of the in-vehicle sensor 220 include a camera, a radar, a LiDAR, a wheel speed sensor, an IMU (Inertial Measurement Unit), and a GNSS (Global Navigation Satellite System) sensor. Information detected by the in-vehicle sensor 220 is transmitted to the processing unit 210.

The in-vehicle device 230 includes a lighting device, an interior lighting device, a horn, a direction indicator, wipers, a door, a door window, a driving device (an engine, an electric motor, or the like), a braking device, a steering device, and the like. The in-vehicle device 230 operates in accordance with the control signal acquired from the processing unit 210. Each device of the in-vehicle device 230 may include an actuator controllable by the processing unit 210. The in-vehicle device 230 operates in accordance with the control signal, thereby the control of the vehicle 1 by the control system 200 is realized.

The communication interface 240 is an interface for communicating with a device outside the vehicle 1 to transmit and receive information. The control system 200 of the vehicle 1 transmits and receives information to and from the management system 100 via the communication interface 240. Information received through the communication interface 240 is transmitted to the processing unit 210.

### 1.3 Processing Flow

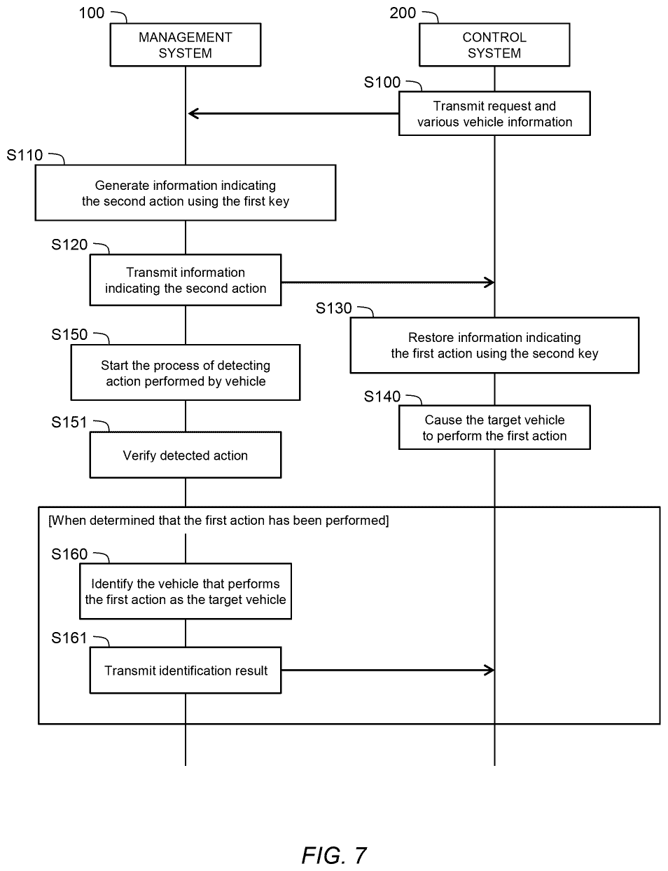

FIG. 7 is a diagram showing an example of a processing flow of the first vehicle identification method realized by the vehicle identification system 10. In the following description, the processing by the management system 100 is executed by the server 110 (more specifically, the processor 120). And the processing by the control system 200 is executed by the processing unit 210 (more specifically, the processor 211).

In step S100, the control system 200 of the target vehicle transmits a request for a function and various necessary vehicle information (vehicle ID, vehicle specifications, the status of the in-vehicle device 230, and the like) to the management system 100. Here, when the public key cryptography is employed in the first vehicle identification method, the target vehicle further generates the first key (public key) from the second key (private key) and transmits the generated first key to the management system 100.

When the management system 100 receives the request and the vehicle information, the management system 100 acquires the first action with reference to the management data 132. The management system 100 may select the first action from among a plurality of candidate actions stored in the management data 132. Alternatively, the management system 100 may determine the first action according to the target vehicle. Alternatively, the management system 100 may determine the first action according to the user of the target vehicle.

Next, in step S110, the management system 100 generates the information indicating the second action from the information indicating the first action using the first key.

Next, in step S120, the management system 100 transmits the generated information indicating the second action to the target vehicle.

Next, in step S130, the control system 200 of the target vehicle restores the information indicating the first action from the information indicating the second action using the second key.

Next, in step S140, the control system 200 causes the target vehicle to perform the first action in accordance with the restored information indicating the first action.

After transmitting the information indicating the second action, the management system 100 starts a process of detecting an action performed by the vehicle 1 in the area 2 using the sensor 150 (step S150). When an action is detected in the detection process, the management system 100 verifies whether the action is the first action (step S151). The verification is performed, for example, by comparing the operation pattern of the detected action with the operation pattern of the first action and determining whether there is a significant difference between the two.

When it is determined that the first action has been performed by the verification, the management system 100 identifies the vehicle 1 that performs the first action as the target vehicle (step S160). Then, the management system 100 transmits the identification result to the target vehicle (step S161). After the step S161, the management system 100 may start providing the requested function.

When it is determined that the first action is not performed by the verification, the management system 100 may resume the detection process. In addition, in step S151, the management system 100 may further verify whether the detected action is the second action. When it is determined that the second action has been performed by the verification, the management system 100 may exclude the vehicle 1 that performs the second action from the target of identification.

### 1.4 Modification

As described above, in the first vehicle identification method, the management system 100 needs to manage the first key and the information indicating the first action. Here, a case is considered where the first vehicle identification method is applied to each of the plurality of areas 2 when the function of AVP or the like is provided over the plurality of areas 2. In this case, each of the plurality of local management devices 110a manages the first key and the information indicating the first action.

However, it is expected that the first key and the information indicating the first action managed by each local management device 110a includes much in common with each other. For example, when the first key is managed for each vehicle 1, the first key for the same vehicle 1 is considered to be common. This is a problem from the viewpoint of management cost. Therefore, in order to address this problem, the vehicle identification system 10 may adopt the following modified embodiment.

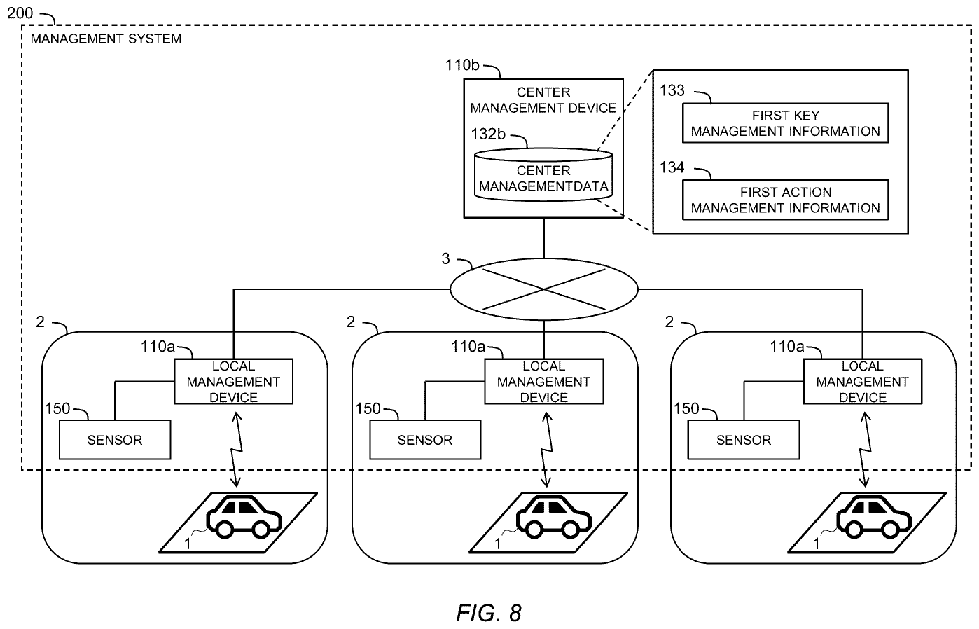

FIG. 8 is a diagram showing an example of the configuration of the vehicle identification system 10 according to the modified embodiment. In the vehicle identification system 10 according to the modified embodiment, the management system 100 includes a plurality of local management devices 110a provided in a plurality of areas 2 and a center management device 110b that manages the plurality of local management devices 110a.

The configuration of each of the plurality of local management devices 110a may be the same as the configuration of the server 110 shown in FIG. 4. However, the management data 132 of each local management device 110a does not manage the information of the first key and the information indicating the first action.

The configuration of the center management device 110b may be the same as the configuration of the server 110 shown in FIG. 4. The center management device 110b is connected to the communication network 3 via the communication interface 140 and communicates with each local management device 110a. However, the center management data 132b of the center management device 110b records first key management information 133 for managing the first key and first action management information 134 for managing the information indicating the first action. That is, in the vehicle identification system 10 according to the modified embodiment, the first key and the information indicating the first action are managed in the center management device 110b.

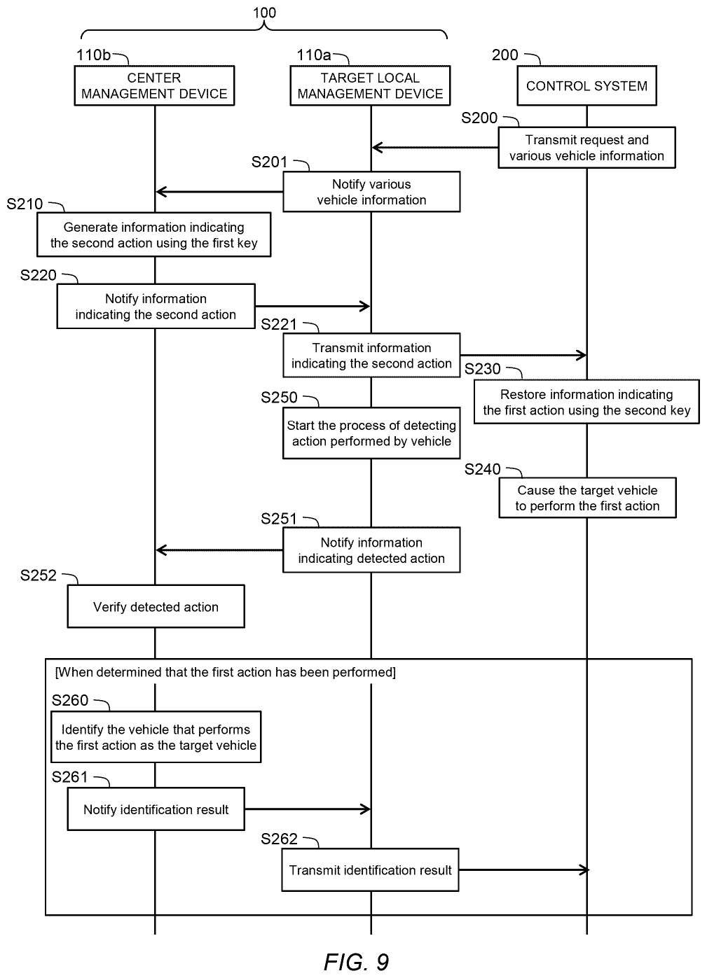

FIG. 9 is a diagram showing a processing flow of the first vehicle identification method realized by the vehicle identification system 10 according to the modified embodiment. In FIG. 9, a target local management device 110a is the local management device 110a provided in a target area where the target vehicle enters and exits among the plurality of areas 2.

In step S200, the control system 200 of the target vehicle transmits a request for a function and various necessary vehicle information to the target local management device 110a.

Next, in step S201, the target local management device 110a notifies the received various vehicle information to the center management device 110b.

When the center management device 110b receives the notification of the vehicle information, the center management device 110b acquires the first action with reference to the first action management information 134.

Next, in step S210, the center management device 110b acquires the first key with reference to the first key management information 133. Then, the center management device 110b generates the information indicating the second action from the information indicating the first action using the first key.

Next, in step S220, the center management device 110b notifies the generated information indicating the second action to the target local management device 110a.

Next, in step S221, the target local management device 110a transmit the notified information indicating the second action to the target vehicle.

Next, in step S230, the control system 200 of the target vehicle restores the information indicating the first action from the information indicating the second action using the second key.

Next, in step S240, the control system 200 causes the target vehicle to perform the first action in accordance with the restored information indicating the first action.

After transmitting the information indicating the second action, the target local management device 110a starts a process of detecting an action performed by the vehicle 1 in the target area using the sensor 150 (step S250). When an action is detected in the detection process, the target local management device 110a transmits information indicating the detected action to the center management device 110b (step S251).

When the center management device 110b receives the notification of the information indicating the detected action, the center management device 110b verifies whether or not the detected action is the first action (step S252).

When it is determined that the first action has been performed by the verification, the center management device 110b identifies the vehicle 1 that performs the first action as the target vehicle (step S260), and notifies the identification result to the target local management device 110a (step S261). When the target local management device 110a receives the notification of the identification result, the target local management device 110a transmits the identification result to the target vehicle (step S262).

As described above, the first vehicle identification method according to the modified embodiment can achieve the same operation and effect as those of the first embodiment described above. In particular, the first vehicle identification method according to the modified embodiment can manage the first key and the information indicating the first action in the center management device 110b. This makes it possible to reduce management cost.

### 2 Second Embodiment

Hereinafter, the vehicle identification method according to a second embodiment will be described. In the following description, differences from the first embodiment will be mainly described, and the contents common to the first embodiment will be appropriately omitted.

### 2.1 Outline

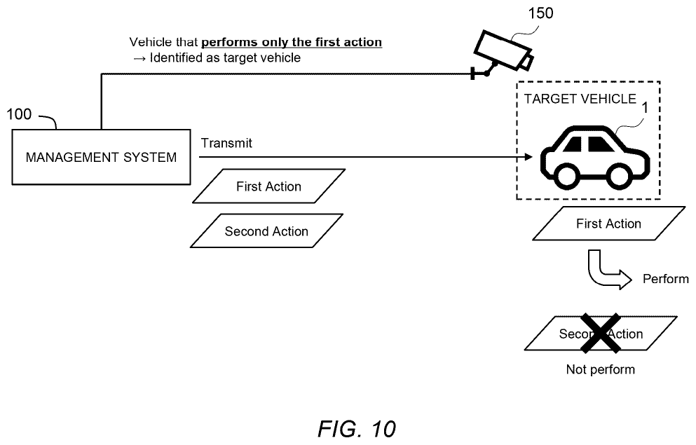

FIG. 10 is a conceptual diagram for explaining an outline of the vehicle identification method according to the second embodiment (hereinafter, simply referred to as the “second vehicle identification method”).

In the second vehicle identification method, the management system 100 manages a first action and a second action. First, in the second vehicle identification method, information indicating both the first action and the second action is transmitted from the management system 100 to the target vehicle.

Next, in the second vehicle identification method, the target vehicle is caused to perform only the first action without performing the second action. This can be realized, for example, as follows.

One of the methods for performing only the first action is to make the second action to an action that the target vehicle does not have capability to perform (hereinafter referred to as the “unperformable action”). According to this method, since the target vehicle cannot perform the second action, the information indicating the second action is not taken into account in the control system 200 of the target vehicle. As a result, it is possible to cause the target vehicle to perform only the first action. In particular, according to this method, the control system 200 of the target vehicle need only be configured to control the target vehicle according to information received from the management system 100. That is, the control system 200 does not need to perform special processing. Therefore, it can be implemented without the processing load and development cost in the control system 200.

The unperformable action can be given in terms of the type, equipment, specifications, and the like of the target vehicle. For example, when the type of the target vehicle is an electric vehicle, an example of the unperformable action is an action of revving up the engine in a specified pattern. Also, for example, when the equipment of the target vehicle does not include door opening/closing control device, an example of the unperformable action is am action of opening/closing the door in a specified pattern. Also, for example, when the target vehicle has a specification that does not accept the operation of a horn by an external system, an example of the unperformable action is an action of sounding the horn in a specified pattern. The management system 100 can determine the second action to be the unperformable action based on the vehicle information acquired from the target vehicle.

Another method for performing only the first action is to transmit the information indicating the second action from the management system 100 to the target vehicle in advance. For example, in AVP, the center management device 110b of the management system 100 transmits the information indicating the second action to the target vehicle in advance when a user makes a reservation for AVP. According to this method, the control system 200 of the target vehicle can recognize which action received from the management system 100 is the second action. Therefore, the control system 200 of the target vehicle can control the target vehicle without considering the information indicating the second action. As a result, it is possible to cause the target vehicle to perform only the first action. In particular, according to this method, the management system 100 can determine the first action and the second action without distinguishing between them. Therefore, the management system 100 can be implemented without increasing the management cost and processing load.

Next, in the second vehicle identification method, the management system 100 detects an action performed by the vehicle 1 using the sensor 150.

Then, in the second vehicle identification method, the management system 100 identifies the vehicle 1 that performs the first action without performing the second action as the target vehicle. The vehicle 1 that performs an action other than the first action is not identified as the target vehicle. In particular, the vehicle 1 that performs both the first action and the second action is not identified as the target vehicle.

As described above, according to the second vehicle identification method, the information indicating both the first action and the second action is transmitted from the management system 100 to the target vehicle. In addition, the target vehicle is caused to performs only the first action without performing the second action. Then, in the management system 100, the vehicle 1 that performs the first action without performing the second action is identified as the target vehicle. As described above, according to the second vehicle identification method, the vehicle 1 that performs both the first action and the second action for which information is transmitted is not identified as the target vehicle. Thus, even if information transmitted from the management system 100 to the target vehicle is intercepted, an unrelated vehicle is prevented from being identified as the target vehicle. As a result, it is possible to more appropriately ensure reliability and safety in the action-based vehicle identification method.

By the way, in the second vehicle identification method, the vehicle 1 that performs both the first action and the second action is considered to be the vehicle 1 that performs an action acquired by a malicious third party through interception. Therefore, the management system 100 may be configured to exclude the vehicle 1 from the target of identification when the vehicle 1 that performs both the first action and the second action is detected. In addition, the management system 100 may be configured to issue an alert to a system operator.

In the above description, the second vehicle identification method has been described with two actions, that is, the first action to be performed by the target vehicle and the second action not to be performed by the target vehicle. The second vehicle identification method can be easily extended to three or more actions, as will be understood from the above description. For example, four actions, a first action, a second action, a third action, and a fourth action, are transmitted from the management system 100 to the target vehicle. Here, the third action and the fourth action are actions not to be performed by the target vehicle. The management system 100 may identify the vehicle 1 that performs the first action and the second action without performing the third action and the fourth action as the target vehicle. By increasing the number of actions to be transmitted, it is expected that reliability and safety are ensured at a higher level.

### 2.2 Processing Flow

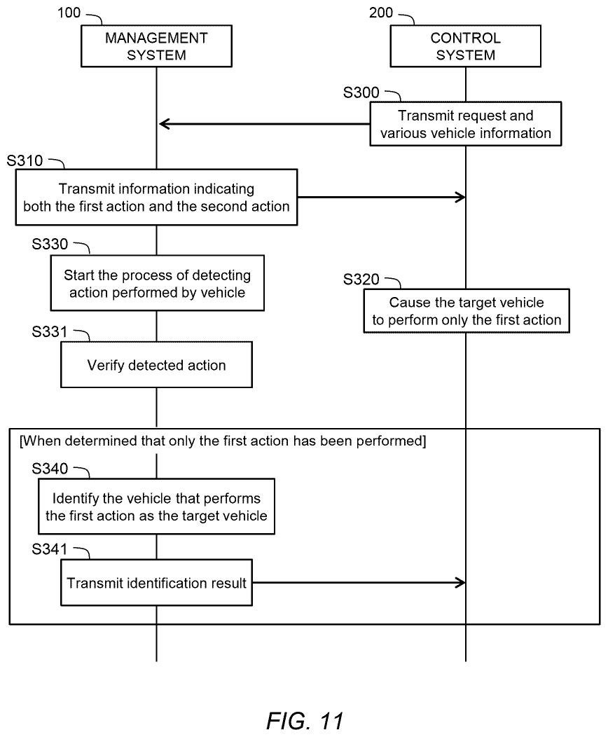

The second vehicle identification method can be realized by the same configuration as the vehicle identification system 10 according to the first embodiment shown in FIG. 6. FIG. 11 is a diagram showing an example of a processing flow of the second vehicle identification method realized by the vehicle identification system 10.

In step S300, the control system 200 of the target vehicle transmits a request for a function and various necessary vehicle information to the management system 100.

When the management system 100 receives the request and the vehicle information, the management system 100 acquires the first action and the second action with reference to the management data 132. Here, the second action may be an unperformable action. Alternatively, the second action may be an action that is transmitted to the target vehicle in advance.

Next, in step S310, the management system 100 transmits the information indicating both the first action and the second action to the target vehicle.

Next, in step S320, the control system 200 of the target vehicle causes the target vehicle to perform only the first action among the first and the second actions.

After transmitting the information indicating both the first action and the second action, the management system 100 starts a process of detecting an action performed by the vehicle 1 in the area 2 using the sensor 150 (step S330). When an action is detected in the detection process, the management system 100 verifies the action (step S331).

When it is determined that only the first action is performed without performing the second action by the verification, the management system 100 identifies the vehicle 1 that performs the first action as the target vehicle (step S340). Then, the management system 100 transmits the identification result to the target vehicle (step S341).

When it is determined that an action other than the first action is performed by the verification, the management system 100 may resume the detection process. In particular, in step S331, the management system 100 may further verify whether the detected action includes both the first action and the second action. Then, when it is determined that both the first action and the second action are performed by the verification, the management system 100 may exclude the vehicle 1 that performs both the first action and the second action from the target of identification.

### 3. Third Embodiment

Hereinafter, the vehicle identification method according to a third embodiment will be described. In the following description, differences from the first embodiment will be mainly described, and the contents common to the first embodiment will be appropriately omitted.

### 3.1 Outline

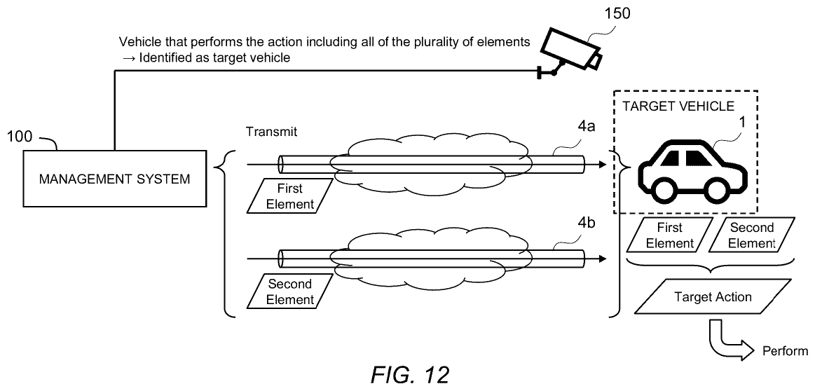

FIG. 12 is a conceptual diagram for explaining an outline of the vehicle identification method according to the third embodiment (hereinafter, simply referred to as the “third vehicle identification method”).

In the third vehicle identification method, the management system 100 manages a plurality of elements constituting a target action. In FIG. 12, a first element and a second element are shown as the plurality of elements. Here, the method for providing the plurality of elements can adopt the following modes.

One of the methods for providing the plurality of elements is to set each of a device for performing the target action and the operation pattern of the device as one element. Therefore, in this case, the plurality of elements includes the device for performing the target action and the operation pattern of the device. For example, in FIG. 10, the first element indicates headlights, and the second element indicates a switching pattern of lighting on and off. The plurality of elements may further include separate elements for constituting the target action. For example, the plurality of elements may further include an element indicating the number of repetitions of the operation pattern.

Another method for providing the plurality of elements is to consider the target action as a combination of a plurality of actions different from each other and to set each action related to the combination as one element. Therefore, in this case, the plurality of elements includes at least a first action and a second action different from the first action. For example, in FIG. 10, the first element indicates an action of blinking the left turn light of a direction indicator in a specified pattern. And the second element indicates an action of blinking the right turn light in a specified pattern.

First, in the third vehicle identification method, information of the plurality of elements is separately transmitted from the management system 100 to the target vehicle via a plurality of different communication paths 4. In FIG. 12, a first communication path 4a and a second communication path 4b are shown as the plurality of different communication paths 4. For example, the first communication path 4a is a path through which the local management device 110a and the target vehicle communicate with each other via a wireless local area network (LAN) or the like. Also, for example, the second communication path 4b is a path through which the center management device 110b and the target vehicle communicate with each other via the communication network 3. In FIG. 12, the first element is transmitted from the management system 100 to the target vehicle via the first communication path 4a. And the second element is transmitted from the management system 100 to the target vehicle via the second communication path 4b.

Next, in the third vehicle identification method, the target vehicle is caused to perform the target action including all of the plurality of elements.

Next, in the third vehicle identification method, the management system 100 detects an action performed by the vehicle 1 using the sensor 150.

Then, in the third vehicle identification method, the management system 100 identifies the vehicle 1 that performs the target action including all of the plurality of elements as the target vehicle. The vehicle 1 that performs an action not including at least one of the plurality of elements is not identified as the target vehicle.

As described above, according to the third vehicle identification method, the information of the plurality of elements constituting the target action is separately transmitted from the management system 100 to the target vehicle via each of the plurality of different communication paths 4. In addition, the target vehicle is caused to perform the target action including all of the plurality of elements. Then, in the management system 100, the vehicle 1 that performs the target action including all of the plurality of elements is identified as the target vehicle. As described above, according to the third vehicle identification method, the target vehicle is not identified by simply performing an action including an element for which information is transmitted through one communication path 4. Thus, even if information transmitted from the management system 100 to the target vehicle is intercepted, an unrelated vehicle is prevented from being identified as the target vehicle. As a result, it is possible to more appropriately ensure reliability and safety in the action-based vehicle identification method.

By the way, in the third vehicle identification method, the vehicle 1 that performs an action not including at least one of the plurality of elements is considered to be the vehicle 1 that performs an action acquired by a malicious third party by interception. Therefore, the management system 100 may be configured to exclude the vehicle 1 from the target of identification when the vehicle 1 that performs an action not including at least one of the plurality of elements is detected. In addition, the management system 100 may be configured to issue an alert to a system operator.

### 3.2 Processing Flow

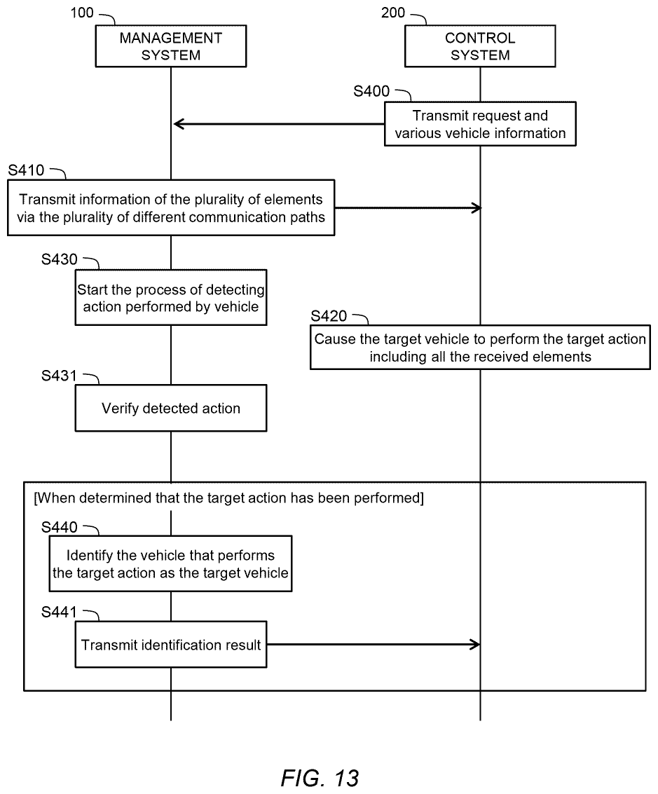

The third vehicle identification method can be realized by the same configuration as the vehicle identification system 10 according to the first embodiment shown in FIG. 6. FIG. 13 is a diagram showing an example of a processing flow of the third vehicle identification method realized by the vehicle identification system 10.

In step S400, the control system 200 of the target car transmits a request for a function and various necessary vehicle information to the management system 100.

When the management system 100 receives the request and the vehicle information, the management system 100 acquires a plurality of elements constituting a target action with reference to the management data 132.

Next, in step S410, the management system 100 transmits the information of the plurality of elements to the target vehicle separately via each of the plurality of different communication paths 4.

Next, in step S420, the control system 200 of the target vehicle causes the target vehicle to perform the target action including all of the plurality of elements.

After transmitting the information indicating the plurality of elements, the management system 100 starts a process of detecting an action performed by the vehicle 1 in the area 2 using the sensor 150 (step S430). When an action is detected in the detection process, the management system 100 verifies the action (step S431).

When it is determined that the target action including all of the plurality of elements has been performed by the verification, the management system 100 identifies the vehicle 1 that performs the target action as the target vehicle (step S440). Then, the management system 100 transmits the identification result to the target vehicle (step S441).

When it is determined that the target action including all of the plurality of elements is not performed by the verification, the management system 100 may resume the detection process. In particular, in step S431, the management system 100 may further verify whether the detected action is an action not including at least one of the plurality of elements. When it is determined that an action not including any element is performed by the verification, the management system 100 may exclude the vehicle 1 that performs the action from the target of identification.

### 4. Fourth Embodiment

Hereinafter, the vehicle identification method according to a fourth embodiment will be described. In the following description, differences from the first embodiment will be mainly described, and the contents common to the first embodiment will be appropriately omitted.

### 4.1 Outline

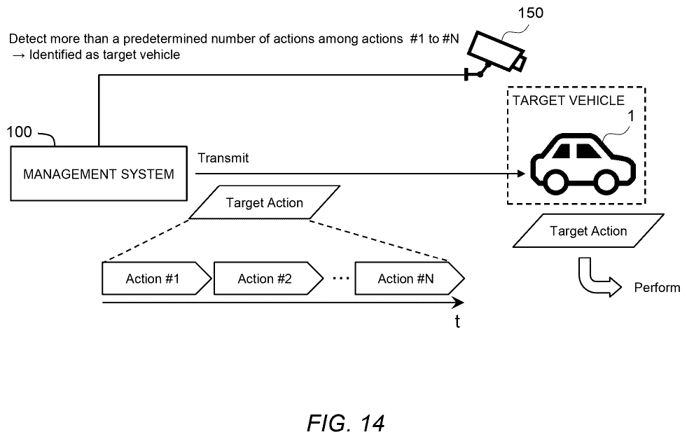

FIG. 14 is a conceptual diagram for explaining an outline of a vehicle identification method according to the fourth embodiment (hereinafter, simply referred to as the “fourth vehicle identification method”).

In the fourth vehicle identification method, the management system 100 manages a target action including a plurality of actions that are consecutive in time. In FIG. 10, the target action includes N actions #1 to #N that are consecutive in time. In this case, the performing the target action means that the actions #1 to #N are performed in this order consecutively in time. The plurality of actions that are consecutive in time are given by, for example, setting the duration of each action or the interval to the next action.

Next, in the fourth vehicle identification method, information of the target action is transmitted from the management system 100 to the target vehicle.

Next, in the fourth vehicle identification method, the target vehicle is caused to perform the target action.

Next, in the fourth vehicle identification method, the management system 100 detects an action performed by the vehicle 1 using the sensor 150.

In the fourth vehicle identification method, the management system 100 compares the detected action with the plurality of actions and identifies the vehicle 1 that performs the detected action as the target vehicle when more than a predetermined number of actions among the plurality of actions are detected. For example, it is assumed that the target action includes seven actions that are consecutive in time of actions #1 to #7, and the predetermined number is set to 5. In this case, the management system 100 compares the detected action with the target action in the order of actions #1 to #7. Then, when five or more of the actions #1 to #7 match, the vehicle 1 that performs the detected action is identified as the target vehicle. Since the actions #1 to #7 are actions that are consecutive in time, the comparison is performed in consideration of the detection time of the detected action. For example, the management system 100 records a timestamp of the detected action and performs comparison based on the timestamp.

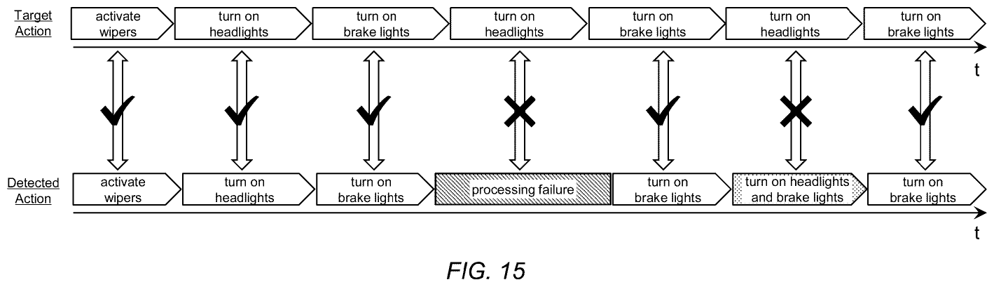

FIG. 15 is a conceptual diagram showing a practical example. FIG. 15 shows a target action including seven actions that are consecutive in time. The detected action includes inaccurate information in part due to a processing failure or a recognition error of the sensor 150. On the other hand, the detected action includes five actions among the seven actions of the target action. Therefore, in this practical example, if the predetermined number is 5 or more, the management system 100 identifies the vehicle 1 that performs the detected action as the target vehicle.

As described above, according to the fourth vehicle identification method, the information indicating the target action including the plurality of actions that are consecutive in time is transmitted from the management system 100 to the target vehicle. In addition, the target vehicle is caused to perform the target action. Then, in the management system 100, when more than a predetermined number of actions among the plurality of actions are detected, the vehicle 1 that performs the detected action is identified as the target vehicle. As described above, according to the fourth vehicle identification method, even if all of the detected action does not match the target action, if more than the predetermined number of actions match, the vehicle 1 that performs the detected action is identified as the target vehicle. This makes it possible to consider a case where a temporary processing failure or a recognition error occurs in the sensor 150, and to improve the success probability of identification. As a result, it is possible to more appropriately ensure reliability and safety in the action-based vehicle identification method.

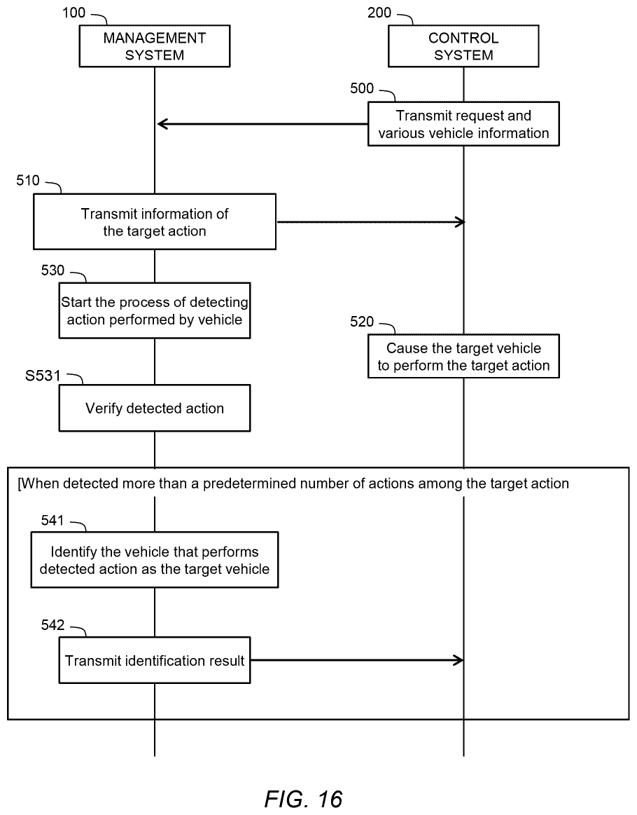

The fourth vehicle identification method can be realized by the same configuration as the vehicle identification system 10 according to the first embodiment shown in FIG. 6. FIG. 16 is a diagram showing an example of a processing flow of the fourth vehicle identification method realized by the vehicle identification system 10.

In step S500, the control system 200 of the target car transmits a request for a function and various necessary vehicle information to the management system 100.

When the management system 100 receives the request and the vehicle information, the management system 100 acquires a target action including a plurality of actions that are consecutive in time with reference to the management data 132.

Next, in step S510, the management system 100 transmits the information indicating the target action to the target vehicle.

Next, in step S520, the control system 200 of the target vehicle causes the target vehicle to perform the target action.

After transmitting the information indicating the target action, the management system 100 starts a process of detecting an action performed by the vehicle 1 in the area 2 using the sensor 150 (step S530). When an action is detected in the detection process, the management system 100 compares and verifies the detected action with a plurality of actions included in the target action (step S531).

When it is determined that more than a predetermined number of actions among the plurality of actions are detected by the verification, the management system 100 identifies the vehicle 1 that performs the detected action as the target vehicle (step S541). Then, the management system 100 transmits the identification result to the target vehicle (step S542).

What is claimed is:

1. A vehicle identification method for identifying a target vehicle including:
in a management system, generating information indicating a second action from information indicating a first action using a first key;
transmitting the information indicating the second action from the management system to the target vehicle;
in the target vehicle, restoring the information indicating the first action from the information indicating the second action using a second key associated with the first key;
causing the target vehicle to perform the first action;
in the management system, detecting an action performed by a vehicle using a sensor; and
in the management system, identifying the vehicle performing the first action as the target vehicle and not identifying the vehicle performing the second action as the target vehicle.

2. The vehicle identification method according to claim 1, wherein
the first key and the second key are a common key.

3. The vehicle identification method according to claim 1, further including:
in the target vehicle, generating a public key that is the first key and a private key that is the second key; and
transmitting information of the public key that is the first key from the target vehicle to the management system.

4. The vehicle identification method according to claim 1, wherein
the management system comprises:
a plurality of local management devices provided in a plurality of areas where vehicles enter and exit;
a center management device managing the plurality of local management devices,
the plurality of local management devices includes a target local management device provided in a target area where the target vehicle enters and exits, and
the vehicle identification method further includes:
in the center management device, managing the information indicating the first key and the first action;
in the center management device, generating the information indicating the second action from the information indicating the first action using the first key;
transmitting the information indicating the second action from the center management device to the target local management device;
transmitting the information indicating the second action from the target local management device to the target vehicle;
in the target local management device, detecting an action performed by a vehicle using the sensor;
transmitting information of the action performed by the vehicle from the target local management device to the center management device; and
in the center management device, identifying the vehicle performing the first action as the target vehicle and not identifying the vehicle performing the second action as the target vehicle.

5. A vehicle identification method for identifying a target vehicle including:
transmitting information indicating both a first action and a second action from a management system to the target vehicle;
causing the target vehicle to perform only the first action without performing the second action;
in the management system, detecting an action performed by a vehicle using a sensor; and
in the management system, identifying the vehicle that performs the first action without performing the second action as the target vehicle, and not identifying the vehicle that performs both the first action and second action as the target vehicle.

6. The vehicle identification method according to claim 5, wherein
the second action is an action that the target vehicle does not have capability to perform.

7. The vehicle identification method according to claim 5, further including
transmitting information indicating the second action from the management system to the target vehicle in advance.

8. A vehicle identification method for identifying a target vehicle including:
transmitting information of a plurality of elements constituting a target action separately from a management system to the target vehicle via each of a plurality of different communication paths;
causing the target vehicle to perform the target action including all of the plurality of elements;
in the management system, detecting an action performed by a vehicle using a sensor; and
in the management system, identifying the vehicle that performs the target action including all of the plurality of elements as the target vehicle, and not identifying the vehicle that performs the action not including at least one of the plurality of elements as the target vehicle.

9. The vehicle identification method according to claim 8, wherein
the plurality of elements includes a device for performing the target action and an operation pattern of the device. 4

10. The vehicle identification method according to claim 8, wherein
the plurality of elements includes a first action and a second action that is different from the first action.
